(19) United States
(12) Patent Application Publication
(10) Pub. No.: US 2016/0275096 A1
(43) Pub. Date: Sep. 22, 2016

(54) META DATA AND DATA VERIFICATION

(71) Applicant: HEWLETT-PACKARD DEVELOPMENT COMPANY, L.P., Houston, TX (US)

(72) Inventor: John Butt, Bristol (GB)

(21) Appl. No.: 15/037,303

(22) PCT Filed: Nov. 27, 2013
(86) PCT No.: PCT/US2013/072145

§ 371 Date: May 17, 2016

(51) Int. Cl. G06F 17/30

(52) U.S. Cl. CPC G06F 17/30156; G06F 17/3012

(57) ABSTRACT

Disclosed herein are a system, non-transitory computer readable medium and method of file verification. A request to verify a file in storage is read. A hierarchy of objects associated with metadata of at least the file is analyzed.

### BACKGROUND

File verification may include authenticating a file in a storage device. Files may be corrupted due to disk failures, I/O errors, database corruption, or operational errors.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, file verification may include authenticating a file in a storage device. Some files may be compressed using a technique known as de-duplication. In de-duplication, a file may be read in segmented units of data and each read unit of data may be compared to previously read units; if a redundant unit is detected, the redundant unit may be replaced with a reference or pointer to the matching unit of data detected previously. The reference or pointer may be much smaller in size than a data unit, which may occur dozens, hundreds, or even thousands of times in a given file. Thus, de-duplication may save a considerable amount of storage.

File verification in a repository with de-duplication may also include verifying the integrity of the de-duplication references. Corrupt de-duplication references may also be caused by disk failures, I/O errors, database corruption, or operational errors, Authenticating files compressed with de-duplication may require the inspection of the de-duplication file system. The depth of the inspection may depend on the level of confidence requested. The higher the level of confidence desired, the more the file system needs to be examined. Unfortunately, an exhaustive inspection of the file system may be extremely expensive and there is no guarantee that the logical objects that need to be retrieved and examined will be arranged in an orderly fashion.

In view of the foregoing, disclosed herein are a system, computer-readable medium, and method of verifying a file of data. In one example, a request to verify a file in a storage device is read. In a further example, a hierarchy of objects associated with metadata of at least the file being verified is analyzed. In another example, the response to the request may be based on an analysis of the objects. In yet a further example, the hierarchy of objects may comprise a root object that indicates whether the given data file is stored in the storage device and a leaf object that contains a unit of data in the file. As will be discussed herein, a hierarchy of objects at least partially associated with aspects of the file may be exploited to provide different levels of verification confidence without overwhelming the file system. The aspects, features and advantages of the present disclosure will be appreciated when considered with reference to the following description of examples and accompanying figures. The following description does not limit the application; rather, the scope of the disclosure is defined by the appended claims and equivalents.

FIG. 1 presents a schematic diagram of an illustrative computer apparatus 100 for executing the techniques disclosed herein. Computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface to communicate with other computers over a network. The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include a data verification module 114. Non-transitory CRM 112 may be used by or in connection with any instruction execution system that can fetch or obtain the logic from non-transitory CRM 112 and execute the instructions contained therein.

Non-transitory computer readable media may comprise any one of many physical media such as, for example, electronic, magnetic, optical, electromagnetic; or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 may comprise any set of instructions to be executed directly (such as machine code) or indirectly (such as scripts) by processor 110. In this regard, the terms “instructions,” “scripts,” or “modules” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

In one example, a storage device (not shown) may store files of data and may store a de-duplication object in lieu of at least one redundant copy of a unit of data in a given file. As noted above, the de-duplication object may comprise a pointer or reference to an occurrence of a unit of data in the file. The storage device may be any device that allows information to be retrieved, manipulated, and stored by processor 110. The storage device may be for example, a persistent storage device. Some examples of storage devices may include, but are not limited to, disk drives, fixed or removable magnetic media drives (e.g., hard drives, floppy or zip-based drives), writable or read-only optical media drives (e.g., CD or DVD), tape drives, or solid-state mass storage devices.

In another example, data verification module 114 may instruct at least one processor 110 to verify that a given file of data and at least one de-duplication pointer associated with the given file is stored in a storage device. In a further example, data verification module 114 may instruct at least one processor 110 to read a hierarchy of objects at least partially associated with metadata of de-duplication references and the file being verified. In another example, data verification module 114 may instruct at least one processor 110 to respond to the request based on an analysis of the objects in the hierarchy.

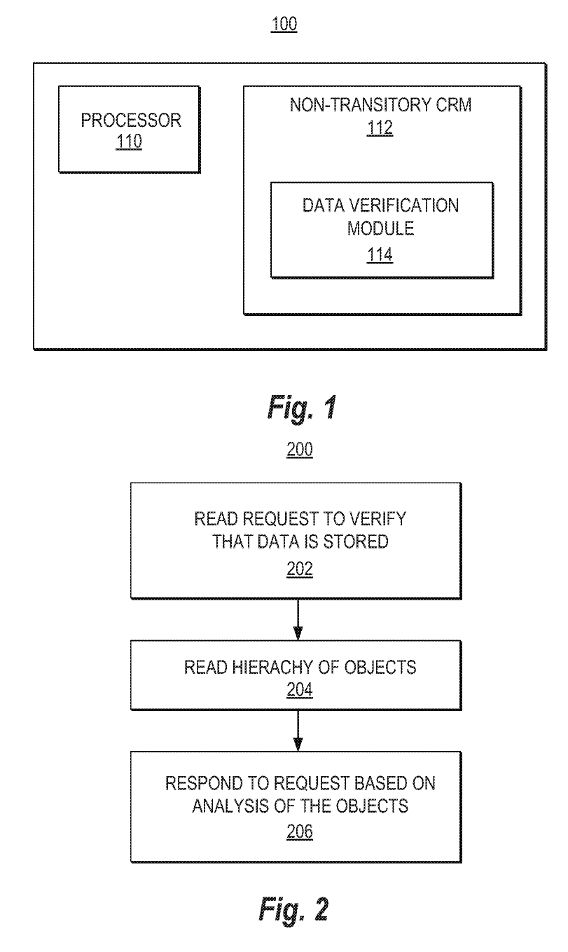

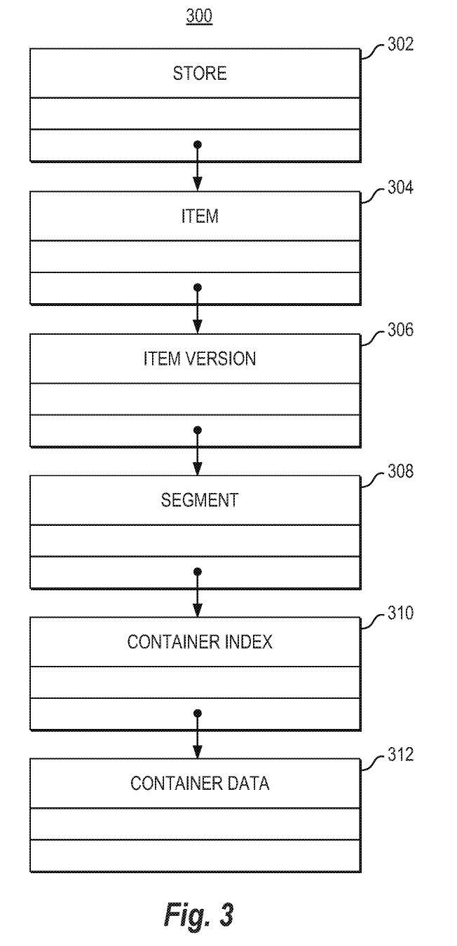

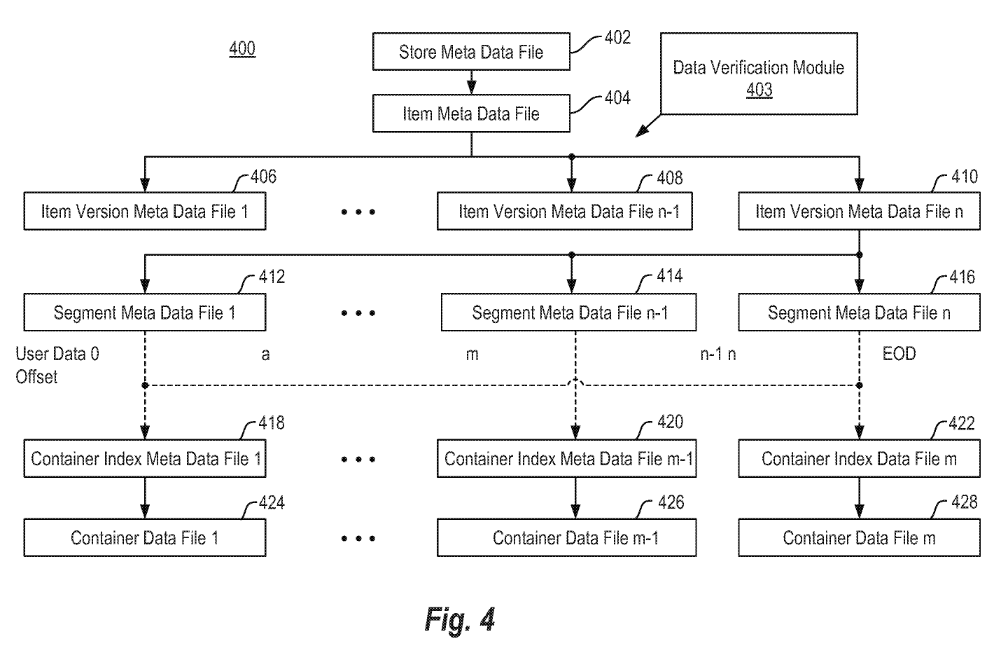

Working examples of the system, method, and non-transitory computer readable medium are shown in FIGS. 2-4. In particular, FIG. 2 illustrates a flow diagram of an example method 200 for verifying a data file. FIGS. 3-4 each show a working example in accordance with the techniques disclosed herein. The actions shown in FIGS. 3-4 will be discussed below with regard to the flow diagram of FIG. 2.

As shown in block 202 of FIG. 2, a request to verify that a file of data is stored in a storage device may be read. In block 204, a hierarchy of objects may be read. The hierarchy of objects may be representative of metadata associated with at least the given data file whose verification is being requested. Referring now to FIG. 3, an example hierarchy of objects is shown. Each object in the hierarchy (i.e., 302, 304, 306, 308, 310, and 312) may actually be a file or a node in a data structure, such as a graph data structure. Each object may contain a link or pointer to the next object in the hierarchy. In this example, the root object 302 may indicate whether the file to be verified is stored in the storage device. This may be the lowest level of confidence sought after by a verification request. That is, a user may simply want to know that the file exists in the storage device. Item object 304 may represent the file being verified and item version object 306 may represent a version of the file represented by item object 304. Thus, there may be an item version object for each version of the file represented by item object 304. An item object 304 may be associated with metadata of the file and each item version object 306 may be associated with metadata of each version of the file.

Segment object 308 may contain the location and the size of a given unit of data in the file. The size of the unit of data represented by segment object 308 may be any size, such as, for example, ten megabytes. In one example, there may be a segment object for each single occurrence of a unit of data detected in the file or in any of its versions. By way of example, if File A has three different versions and data unit “ABC” occurs three times in the first version, three times in the second version, and twice in the third version there may still be only one segment object for data unit “ABC” instead of eight. Container index object 310 may be another intermediate object associated with metadata of at least one de-duplication reference or pointer associated with the file being verified. A container index object 310 may include a de-duplication reference for a unit of data represented by a segment object 308. Container index object 310 may also comprise a count of how many times the unit of data occurs in the file and in which versions they occur. Referring back to the example above, container index object 310 may indicate that the unit of data “ABC” occurs eight times (three times in the first version, three times in the second version, and twice in the third). Finally, container data object 312 may be a leaf object containing the actual unit of data.

Referring back to FIG. 2, a response based on an analysis of the objects may be sent to the originator of the request, as shown in block 206. In one example, a user may specify a level of confidence in the verification request and the level of confidence may be determined when the verification request is received, Referring now to FIG. 4, a more detailed depiction of the example hierarchy is shown. In another example, data verification module 403 may determine a level in the object hierarchy that coincides with the level of confidence in the request. If the verification request merely requires confirmation that the file exists, data verification module 403 may determine if the root object 402 exists and reply based on the information in root object 402. However, the verification request may require a higher level of confidence. In this instance, data verification module 403 may delve deeper into the hierarchy. For example, the verification request may ask to verify whether a particular version of the file has been stored successfully. In this instance, data verification module 403 may check the information contained in intermediate objects 406, 408, or 410 via intermediate object 404. As noted above, each version may be associated with its own item version object. Furthermore, the request may contain an even higher level of confidence such that it requests confirmation that each de-duplication object is referencing the correct unit of data. As noted above, each single occurrence of a data unit may be associated with a segment object. In FIG. 4, some of these objects are shown as segment objects 412, 414, and 416. Data verification module 403 may cross check between container index items 418, 420, and 422, and the segment objects 412, 414, 416.

In yet another example, a request may require verification of one or more of the actual units of data to ensure that each unit is not corrupt. In this instance, data verification module 403 may analyze the container objects, which are illustrated as leaf objects 424, 426, and 428. Thus, the data verification module can determine the correct level within the hierarchy in order to meet the level of confidence in the request.

Advantageously, the foregoing system, method, and non-transitory computer readable medium may confirm the integrity of a file in a de-duplication repository without burdening the file system. Furthermore, the verification request can be met with higher levels of confidence in a way that does not necessitate expensive retrieval of file system metadata. In turn, users of programs that access the de-duplicated data can be sure that the data is accurate and the de-duplication references are correct.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a storage device for storing data and de-duplication references associated with the data;
a data verification module which, if executed, instructs at least one processor to:
read a request to verify that a given file of data is stored in the storage device;
read a hierarchy of objects at least partially associated with metadata of the de-duplication references and the given file; and
respond to the request based on an analysis of the objects in the hierarchy.

2. The system of claim 1, wherein the data verification module, if executed, further instructs at least one processor to determine a level of confidence in the request to verify that the given file is stored.

3. The system of claim 2, wherein the data verification module, if executed, further instructs at least one processor to determine a level in the hierarchy that coincides with the level of confidence.

4. The system of claim 1, wherein the hierarchy of objects comprises a root object that indicates whether the given file is stored in the storage device and a leaf object containing a unit of data in the given file.

5. The system of claim 4, wherein the hierarchy comprises an intermediate object associated with metadata of at least one de-duplication reference associated with the given file.

6. A non-transitory computer readable medium having instructions therein which, if executed, cause a processor to:
read a request to verify that a given data file and at least one de-duplication pointer associated with the given data file is stored in a storage device;
analyze a hierarchy of objects representative of metadata associated with at least the given data file and the at least one de-duplication pointer;
determine a level of confidence in the request; and
respond to the request based on an analysis of the hierarchy of objects.

7. The non-transitory computer readable medium of claim 6, wherein the instructions therein, if executed, further instruct at least one processor to determine a level in the hierarchy that coincides with the level of confidence.

8. The non-transitory computer readable medium of claim 6, wherein the hierarchy of objects comprises a root object that indicates whether the given data file is stored in the storage device and a leaf object containing a unit of data in the given file.

9. The non-transitory computer readable medium of claim 6, wherein the hierarchy comprises an intermediate object associated with metadata of the at least one de-duplication pointer.

10. A method comprising
reading, using at least one processor, a request to verify that a data file and at least one de-duplication pointer associated with the data file is in persistent storage;
analyzing, using at least one processor, a hierarchy of objects corresponding to metadata associated with at least the data file, the at least one de-duplication pointer, and the persistent storage; and
responding, using at least one processor, to the request based on an analysis of objects in the hierarchy.

11. The method of claim 10, further comprising determining, using at least one processor, a level of confidence in the request to verify that the data file is stored.

12. The method of claim 11, further comprising determining, using at least one processor, a level in the hierarchy that coincides with the level of confidence.

13. The method of claim 10, wherein the hierarchy of objects comprises a root object that indicates whether the data file is stored in the persistent storage and a leaf object containing a unit of data in the data file.

14. The method of claim 13, wherein the hierarchy comprises an intermediate object associated with metadata of the at least one de-duplication pointer associated with the data file.
